(19) United States
(12) Patent Application Publication
(10) Pub. No.: US 2023/0393037 A1
(43) Pub. Date: Dec. 7, 2023

(54) OCULAR TISSUE SAMPLING DEVICE

(71) Applicant: University of Utah Research Foundation, Salt Lake City, UT (US)

(72) Inventors: Frans Vinberg, Millcreek, UT (US); Jordan Allen, Sandy, UT (US)

(21) Appl. No.: 18/328,609

(22) Filed: Jun. 2, 2023

Related U.S. Application Data
(60) Provisional application No. 63/348,919, filed on Jun. 3, 2022.

(51) Int. Cl. G01N 1/28; B01L 3/00

(52) U.S. Cl. CPC G01N 1/286; B01L 3/508; B01L 2200/025; B01L 2300/0654; G01N 2001/2873

(57) ABSTRACT

Disclosed is an ocular tissue sampling device that enables both imaging of an ex vivo eye and procurement of a tissue sample therefrom. The device includes an eye support assembly configured to secure the eye, a scanner assembly configured to enable imaging of the eye, and a tissue sampling assembly connected to the scanner assembly and configured to obtain a tissue sample from the eye. The tissue sampling assembly includes a biopsy member that is selectively adjustable between a first configuration for imaging of the eye, and a second configuration for procurement of a tissue sample from the eye.

### CROSS-REFERENCE TO RELATED APPLICATIONS

This Application claims priority to and the benefit of U.S. Provisional Patent Application No. 63/348,919, filed on Jun. 3, 2022 and titled “Ocular Tissue Sampling Device,” the entirety of which is incorporated herein by reference.

### BACKGROUND

Optical coherence tomography (OCT) is a non-invasive clinical imaging modality used to image the back of the eye of patients to diagnose eye diseases. OCT can provide detailed cross-sectional images of the eye. It allows ophthalmologists to visualize the structures within the eye, including the retina, optic nerve, and cornea, with effective resolution and depth.

OCT works based on the principle of low-coherence interferometry. A near-infrared light source is used to create a beam of light, which is split into two paths. One path is directed toward the eye, while the other serves as a reference. The light that is reflected back from the eye and the reference light are recombined, and the resulting interference pattern is analyzed. By measuring the differences in the arrival times of the reflected light from different depths within the eye, OCT creates cross-sectional images of the eye's structures. This provides information about the thickness, topography, and integrity of various ocular layers.

In retinal imaging, OCT is particularly useful for diagnosing and monitoring diseases such as macular degeneration, diabetic retinopathy, and glaucoma. It enables the visualization of the retinal layers, allowing the detection of abnormalities and changes over time. This helps ophthalmologists to determine the progression of diseases, plan appropriate treatment strategies, and assess treatment outcomes.

Researchers study human eye diseases by using ex vivo donor eyes, but conventional clinical OCT systems are not designed to scan images of ex vivo human eyes. Moreover, scientists need to extract tissue samples from specific regions of the eye, such as from the fovea. To do this by hand with sufficient precision can be challenging, particularly in dim light environments required for sample preparation for physiology research.

Obtaining a fovea sample from a donor eye presents several challenges due to the unique anatomical and functional characteristics of the fovea, which is the central and most critical region of the retina responsible for high-resolution vision. The fovea contains a high density of cone photoreceptor cells, which are responsible for color perception and detailed visual acuity.

The fovea is a small, specialized area measuring only about 1.5 mm in diameter. Its precise location at the center of the macula makes it challenging to isolate and extract a sample. The delicate nature of the fovea and the need for precise extraction techniques make it a technically demanding procedure. Further, retaining the integrity and functionality of the foveal tissue is crucial for studying its unique cellular composition and characteristics. The fovea has a complex arrangement of photoreceptor cells, specialized Muller cells, and other retinal layers that require meticulous handling to maintain their structure and function post-extraction. The rapid deterioration of cellular viability and potential ischemic damage further complicates the preservation process.

Previous approaches have focused on procuring foveal samples by hand (see, e.g., T. Cabral et al., “Dissection of Human Retina and RPE-Choroid for Proteomic Analysis,” J. Vis. Exp. JoVE, no. 129, p. 56203, Nov. 2017) or have described various systems for use in conjunction with OCT. However, the state of the art lacks a device capable of both (1) enabling accurate guidance of an OCT scanner and (2) utilizing that guidance to effectively procure a tissue sample such as a fovea sample.

Accordingly, there remains an ongoing need for improved ocular tissue sampling devices.

### SUMMARY

Disclosed herein is an ocular tissue sampling device that enables both imaging of an ex vivo eye and procurement of a tissue sample therefrom. The device includes an eye support assembly configured to secure the eye, a scanner assembly configured to image the eye, and a tissue sampling assembly connected to the scanner assembly and configured to obtain a tissue sample from the eye.

The tissue sampling assembly includes a biopsy member that is selectively adjustable between a first configuration for imaging of the eye and a second configuration for procurement of a tissue sample from the eye. For example, in the first configuration the biopsy member can be positioned out of alignment with the optical axis of the scanner assembly to allow imaging of the eye, and in the second configuration the biopsy member is aligned with the optical axis in preparation for obtaining a target tissue sample (e.g., the fovea) identified by the imaging.

The tissue sampling assembly can include a connector that attaches to the scanner assembly. The connector enables the biopsy member to move between the first and second configurations. In some embodiments, the biopsy member is attached to the connector via a hinged connection, and movement between the first and second configurations comprises moving the biopsy member about the hinged connection.

In some embodiments, the biopsy member is selectively attachable to the connector via a slide connection, and movement between the first and second configurations comprises attaching or detaching the biopsy member via the slide connection. The biopsy member and connector can make the slide connection using a mount track and corresponding grooves, for example, enabling attachment of the biopsy member to the connector in a manner that readily and accurately positions the biopsy member along the intended optical axis.

The biopsy member can include a biopsy punch that extends downward toward the tissue sampling assembly when in the second configuration. For example, the biopsy member can include a protrusion or other attachment feature that enables attachment of a disposable biopsy punch thereto. The attachment can be made via friction fit or other suitable attachment means.

In some embodiments, the scanner assembly comprises an OCT scanner, and may include a distance sensor configured to determine distance between the scanner assembly and the eye support assembly.

The eye support assembly can include a vacuum chamber and an eye holder disposed above and connected to the vacuum chamber. The eye holder is configured to receive a posterior segment of the eye and the vacuum chamber is configured to provide suction to the eye to secure the eye within the eye holder. The eye holder can include a contoured and perforated upper surface.

The ocular tissue sampling device can include a stage assembly comprising a stage platform on which the eye support assembly is attached. The stage assembly can comprise an orientation member configured to enable tip, tilt, and rotation of the eye support assembly and/or a horizontal translation member configured to selectively move the eye support assembly horizontally upon the stage platform.

The stage can be connected to a vertical translation member configured to selectively move the stage platform vertically and thereby move the eye support assembly vertically relative to the scanner assembly and tissue sampling assembly. In this manner, the vertical translation member can aid in obtaining the targeted tissue sample under fine control.

The ocular tissue sampling device can comprise a frame that includes a vertical support member and a scanner mount attached to the vertical support member. The scanner assembly can attach to the scanner mount in a manner that enables rotation of the scanner assembly along a horizontal plane. The frame can further comprise an adjustment table from which the vertical support extends such that vertical table movement causes corresponding vertical movement of the scanner assembly and tissue sampling assembly.

An example method for obtaining an ocular tissue sample using an ocular tissue sampling device includes: securing an ex vivo eye in an eye support assembly; imaging the eye using a scanner assembly to identify a target tissue of the eye for biopsy and thereby aligning an optical axis of the scanner assembly with the target tissue of the eye (e.g., the fovea); moving a biopsy member into alignment with the optical axis of the scanner assembly; and moving the scanner assembly and biopsy member relative to the eye support assembly to bring the biopsy member into contact with the target tissue of the eye.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 illustrates an example ocular tissue sampling device comprising an eye support assembly, a scanner assembly, and a tissue sampling assembly, the device configured to enable both imaging of an ex vivo eye and procurement of a tissue sample from the eye;

FIG. 2A illustrates the tissue sampling assembly of the ocular tissue sampling device with a biopsy member disposed in a first configuration in which the biopsy member is not aligned with the optical axis of the scanner assembly and imaging of the eye is therefore enabled;

FIG. 2B illustrates the tissue sampling assembly of the ocular tissue sampling device with the biopsy member disposed in a second configuration in which the biopsy member is aligned with the optical axis of the scanner assembly and procurement of a tissue sample from the eye is therefore enabled;

FIG. 3 illustrates an embodiment of the tissue sampling assembly comprising a hinged connection;

FIG. 4 illustrates an embodiment of the tissue sampling assembly comprising a slide connection;

FIG. 5 illustrates another embodiment of the ocular tissue sampling device where the tissue sampling assembly includes the slide connection of FIG. 4;

FIG. 6 illustrates an exploded view of the eye support assembly; and

FIG. 7 illustrates a stage assembly configured to enable fine movement of the eye support assembly relative to the scanner assembly and tissue sampling assembly.

### DETAILED DESCRIPTION

### Introduction

As discussed above, conventional tissue sampling systems are not capable of both (1) enabling accurate guidance of an optical scanner such as an OCT scanner and (2) utilizing that guidance to effectively procure a tissue sample such as a fovea sample. Conventional systems may, for example, lack a solid surface underneath the ex vivo eye that supports the eye while a sample is obtained (e.g., while a biopsy punch is applied to the eye) or lack means for firm, fixed stabilization of the eye (e.g., to prevent rotational and/or translational movement) during sample procurement.

Conventional systems are also typically used as tools to train surgeons in various eye surgeries. While such systems may provide adequate experiences relative to ophthalmic surgery (e.g., dynamic stability, eyes positioned in fabricated heads, etc.), Such systems are not optimized for obtaining samples from an ex vivo specimen. Specimen retrieval often requires that the eye be fixed firmly in place to obtain precise samples, particularly for targets as small as the fovea, for example, which is only about 1.5 mm in diameter. Many such devices either do not include a support surface underneath the eye, or if they do include such a surface, it is not stable enough to allow for repeated use of a biopsy punch for sample procurement.

In contrast, the disclosed ocular tissue sampling device can beneficially enable both (1) accurate guidance of an optical scanner, such as an OCT scanner and (2) effective procurement of a tissue sample, such as a fovea sample. As described in more detail below, embodiments of the disclosed ocular tissue sampling device can effectively hold and stabilize an ex vivo eye while an optical scanner is used to guide tissue procurement from the eye. The device also beneficially provides sufficient structure underneath the eye to support the eye during sample procurement and to allow repeated use of a biopsy punch.

The disclosed ocular tissue sampling device enables accurate and relatively rapid procurement of tissue samples. The quality of such samples can be greater than those obtained through conventional hand dissection, where errors are common due to the natural unsteadiness of the human hand, as well as the propensity of eye samples to move during dissection. Additionally, the speed at which samples can be obtained using the disclosed device can beneficially enhance/lengthen the viability of the sample, which is useful for research purposes.

The embodiments described herein are primarily directed to imaging and procuring a tissue sample from an ex vivo eye. It will be understood, however, that the same components and principles can be utilized to image and obtain samples from other specimen types (i.e., other organs or tissues). For example, the “eye support assembly” of the disclosed embodiments may be used and optionally modified as needed to secure other types of organs or tissues for imaging and procurement of a target portion thereof.

### Example Ocular Tissue Sampling Device

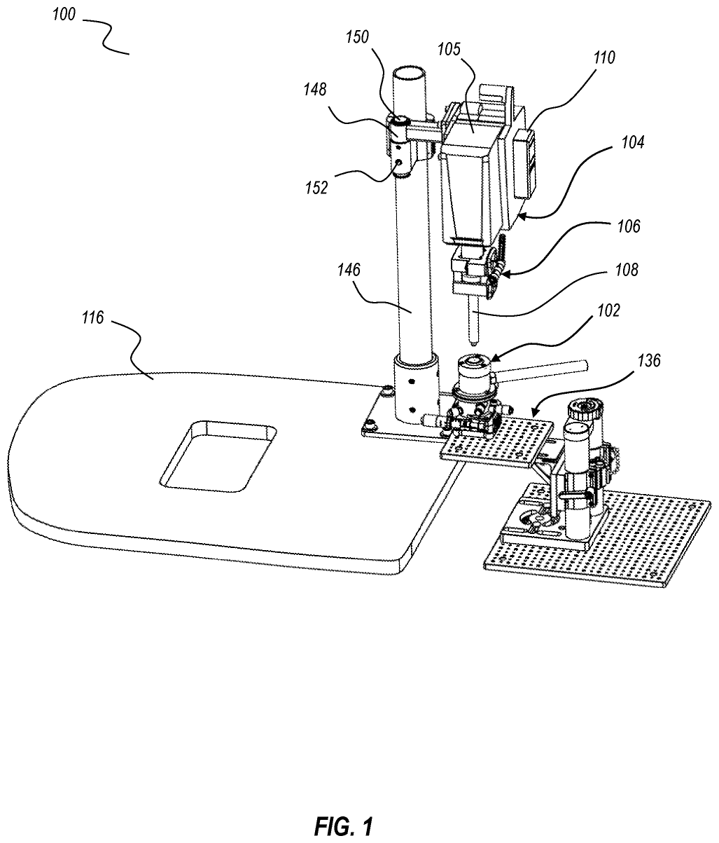

FIG. 1 illustrates an example ocular tissue sampling device 100. The illustrated device 100 includes an eye support assembly 102, a scanner assembly 104, and a tissue sampling assembly 106 connected to the scanner assembly 104. The eye support assembly 102 is configured to secure an ex vivo eye. The scanner assembly 104 includes a scanner 105 (e.g., an OCT scanner) capable of imaging the ex vivo eye secured by the eye support assembly 102. For example, the scanner 105 can be used to identify and/or locate one or more target tissues of the ex vivo eye, such as the fovea.

The scanner assembly 104 includes an optical axis. As used herein, the term “optical axis” refers to the line defined by the path the light takes from the scanner 105 to the eye support assembly 102. The optical axis is defined by the arrangement of the lens system of the particular scanner used.

The tissue sampling assembly 106 includes a biopsy member 108 that can be moved between a first configuration in which the biopsy member 108 is out of alignment with the optical axis and a second configuration in which the biopsy member 108 is aligned with the optical axis. In other words, the biopsy member 108 can be adjusted so that during imaging it does not hinder operation of the scanner 105, but can then be moved into alignment with the optical axis during tissue procurement.

In use, the scanner 105 can be operated to locate a target tissue of the eye while the biopsy member 108 is in the first configuration. Then, with the optical axis aligned with the target tissue, the biopsy member 108 can be moved to the second configuration. This brings the biopsy member 108 into alignment with the optical axis and also beneficially brings the biopsy member 108 into alignment with the target tissue, allowing accurate retrieval of the target tissue once the biopsy member 108 is brought into contact with the eye.

The scanning assembly 104 can also include a distance sensor 110 (e.g., a laser distance sensor such as the GLM20 available from BOSCH) to aid in maintaining consistency between scanning of the eye specimen and excision of target tis sue.

The illustrated embodiment includes a frame designed to support the scanning assembly 104 and the tissue sampling assembly 106. The frame can include a table 116 (e.g., a height-adjustable table, such as a pneumatic table) connected to a vertical support 146. The vertical support 146 extends upward from the table 116 and connects to a scanner adaptor 148. The scanner adaptor 148 is configured to attach to the scanner assembly 104. The vertical support 146 has a height sufficient to position the scanner assembly 104 a sufficient distance from the eye support assembly 102 to allow movement of the biopsy member 108 into the space therebetween.

In the illustrated embodiment, the scanner adaptor 148 includes a pin 150 that provides a pivotable connection to the scanner assembly 104, allowing the scanner assembly 104 to be rotated about the pin. The rotational position of the scanner assembly 104 can be locked in place with a set screw 152 and/or other suitable fixation mechanism.

The illustrated embodiment also includes a stage assembly 136 for supporting the eye support assembly 102 and enabling fine positional adjustments of the eye support assembly 102. The stage assembly 136 is described in more detail below.

In the illustrated embodiment, scanning assembly 104 and tissue sampling assembly 106 are positioned above the eye support assembly 102, with the scanner 105 pointed downward toward the eye. This arrangement is preferable for achieving the combined imaging and sample procurement functions of the device 100, however, other embodiments may position the eye support assembly 102 above the scanning assembly 104 and/or tissue sampling assembly 106.

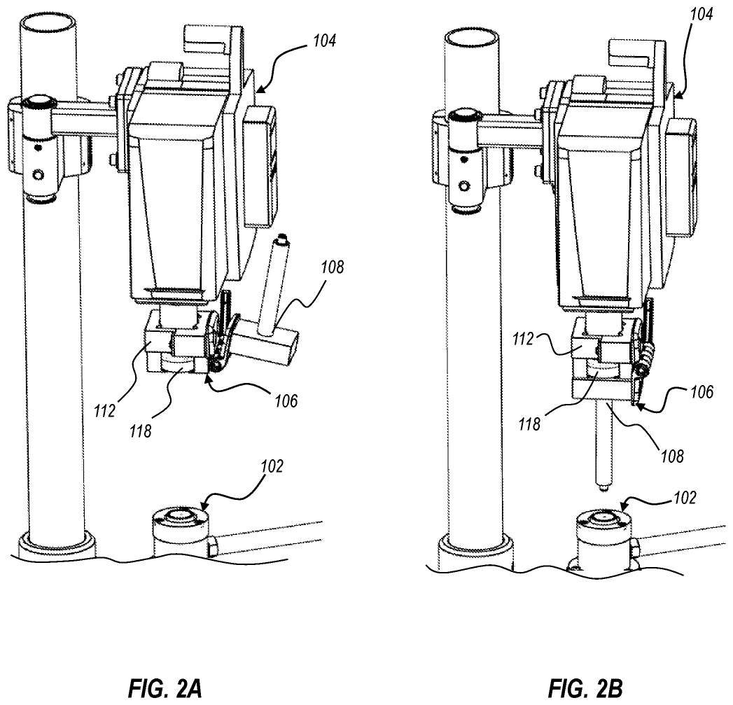

FIGS. 2A and 2B illustrate adjustment of the biopsy member 108 between a first configuration and a second configuration. Other components of device 100 are removed from the view to better illustrate the adjustable features of the biopsy member 108.

FIG. 2A illustrates the tissue sampling assembly 106 of the device 100 with the biopsy member 108 disposed in a first configuration in which the biopsy member 108 is not aligned with the optical axis of the scanner assembly 104 and imaging of the eye is therefore enabled. FIG. 2B illustrates the tissue sampling assembly 106 with the biopsy member 108 disposed in the second configuration in which the biopsy member 108 is aligned with the optical axis of the scanner assembly 104 and procurement of a tissue sample from the eye is therefore enabled.

In this embodiment, tissue sampling assembly 106 includes a connector 112 to which the biopsy member 108 is attached via a hinged connection. The connector 112 provides a means for attaching the biopsy member 108 to the scanner assembly 102. In the illustrated embodiment, the connector 112 is attached around the downward most portion of the scanner lens 118. The hinged connection allows the biopsy member 108 to be readily moved between the first and second configurations. As explained in more detail below, other embodiments may couple the connector 112 and the biopsy member 108 using other means, such as with a sliding connection.

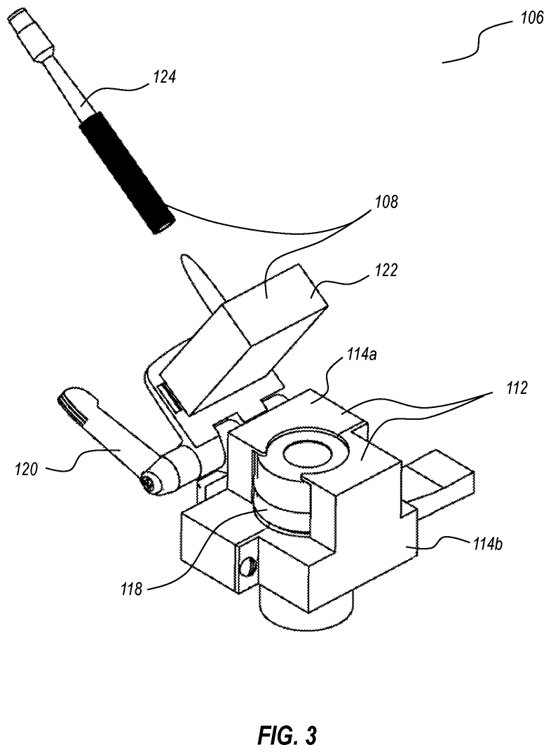

FIG. 3 illustrates a detailed view of the tissue sampling assembly 106. The view is shown “upside down” to better illustrate certain features. As shown, the connector 112 can include sections 114a and 114b that fit together around scanner lens 118. The sections 114a and 114b can fit together via a tab/slot connection, friction fit connection, magnetic connection, adhesive, and/or other suitable fixation means. An O-ring and/or other seal aid can be utilized to enhance the fit of the connector 112 to the scanner lens 118.

The biopsy member 108 includes a biopsy mount 122 which is attached to the connector 112 via the hinged connection, and a biopsy punch 124 (e.g., an INTEGRA MILTEX disposable biopsy punch). The biopsy punch 124 can be detachably connected to the biopsy mount 122 via a friction fit to a suitably shaped protrusion, via a tab/slot connection, threaded connection, magnetic connection, adhesive, and/or other suitable fixation means. The rotational position of the biopsy mount 122 relative to the connector 112 can be locked using lock 120. Any suitable hinge locking mechanism known in the art may be utilized.

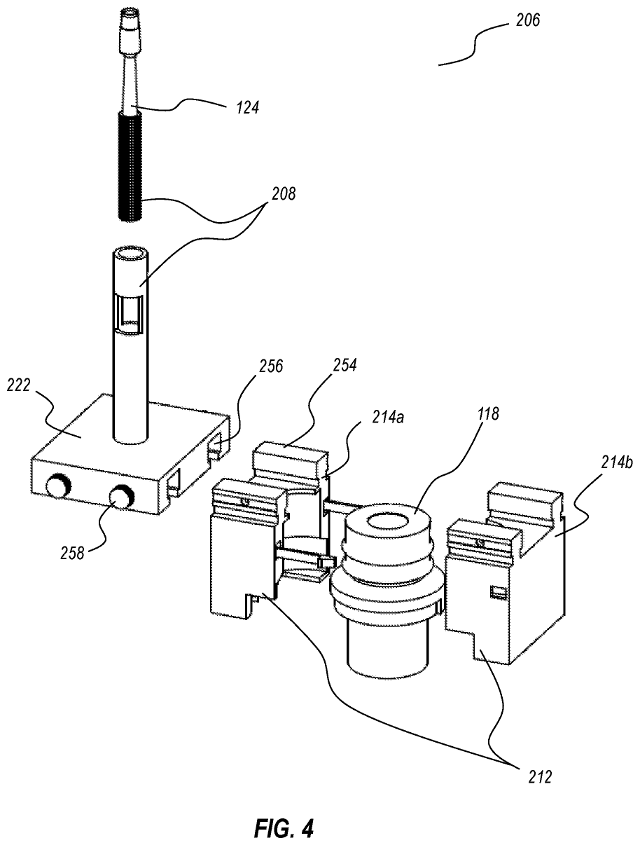

FIG. 4 illustrates a detailed view of an alternative embodiment of a tissue sampling assembly 206 in which the biopsy member 208 is connected via a slide connection. As with tissue sampling assembly 106, tissue sampling member 206 includes a connector 212 that attaches to the scanner lens 118. The connector 212 can include sections 214a and 214b that fit together around scanner lens 118 and provide a platform for centering the biopsy member 208 with the optical axis. The sections 214a and 214b can fit together via a tab/slot connection (as shown), friction fit connection, magnetic connection, adhesive, and/or other suitable fixation means. An and/or other suitable seal aid can be utilized to enhance the fit of the connector 212 to the scanner lens 118.

As shown, the connector 212 forms a mount track 254 that corresponds to grooves 256 of the biopsy mount 222. For example, the mount track 254 and grooves 256 can include mating key features that ensure proper alignment when the biopsy mount 222 is slid onto the connector 212. The biopsy mount 222 can include one or more spring plungers 258 that enable locking of the biopsy mount 222 to the connector 212 once the biopsy mount 222 is properly centered. For example, the mount track 254 can include receptacles that correspond to and receive the spring plungers 258 when they are aligned therewith.

As with biopsy member 108, a biopsy punch 124 can be detachably connected to the biopsy mount 222 of biopsy member 208 via a friction fit to a suitably shaped protrusion, via a tab/slot connection, threaded connection, magnetic connection, adhesive, and/or other suitable fixation means.

The biopsy member 208 can be detached from the connector 212 during imaging of the eye. Then, once a suitable target tissue has been identified, the biopsy member 208 can be attached to the connector 212 via the slide connection in preparation for obtaining the target tissue. The connector 212 and biopsy mount 222 ensure effective centering of the biopsy punch 124 with the optical axis and thus with the target tissue, beneficially enabling accurate sample procurement in following steps.

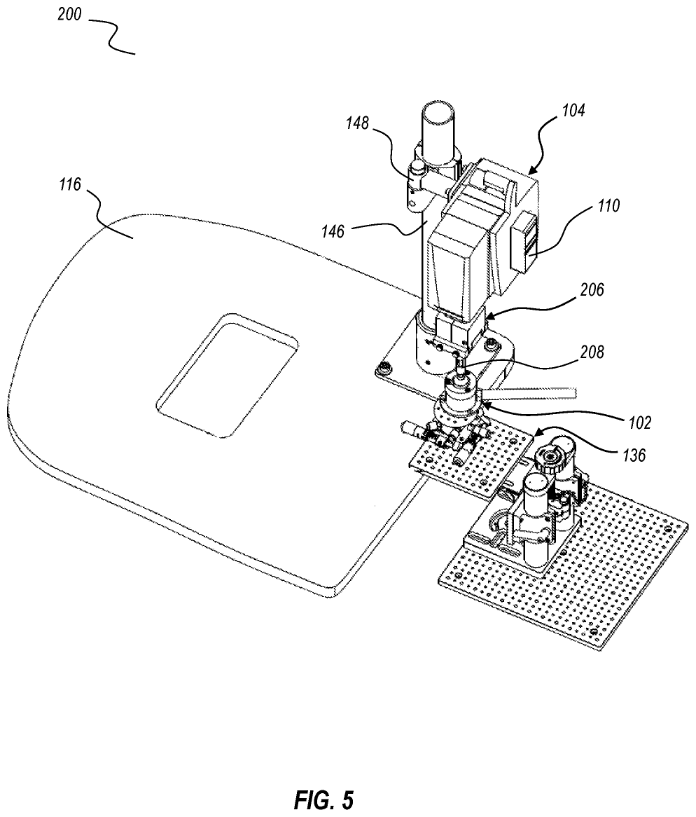

FIG. 5 illustrates another embodiment of the ocular tissue sampling device 200 where the tissue sampling assembly 206 includes the biopsy member 208 and slide connection of FIG. 4. The device 200 can otherwise be similar to device 100, and similar components are illustrated in FIG. 5. Any reference herein to device 100 is applicable to device 200, and except for the components specifically discussed as being different, any of the features of device 100 may be utilized with device 200.

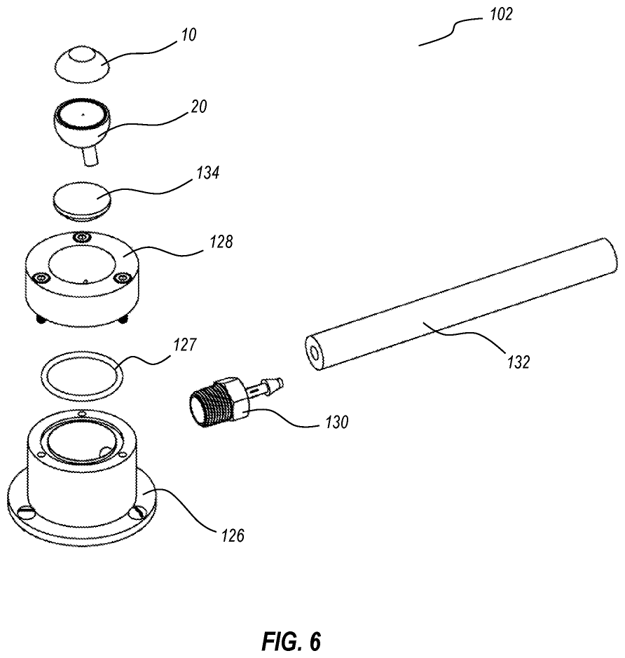

FIG. 6 illustrates an exploded view of the eye support assembly 102. The eye support assembly 102 includes a vacuum chamber 126 and an eye holder 128 connected thereto. The vacuum chamber 126 is configured to provide suction for holding the ex vivo eye securely in place against the upper surface of the eye holder 128. The vacuum chamber 126 can, for example, be connected to vacuum tubing 132 via a barbed fitting 130 and/or other suitable connection. The vacuum tubing 132 can be connected to a suitable vacuum source (not shown) to provide the desired suction force. An O-ring 127 and/or other suitable seal aid can be included in the connection between the vacuum chamber 126 and the eye holder 128.

The upper surface of eye holder 128 can be contoured to better match the anatomy of the ex vivo eye. The upper surface of the eye holder 128 can also include one or more perforations to allow the applied vacuum to hold the received eye. In use, the anterior eye 10 can be dissected while the posterior eye 20 is secured by suction to the eye holder 128.

A barrier material 134 may be positioned between the posterior eye 20 and the eye holder 128. The barrier material 134 can include silicone, filter paper, and/or other suitable barrier material. Use of a barrier material 134 can help to preserve the integrity of the eye while suction forces are applied to secure the eye. The eye can be attached to the barrier material 134 by an adhesive.

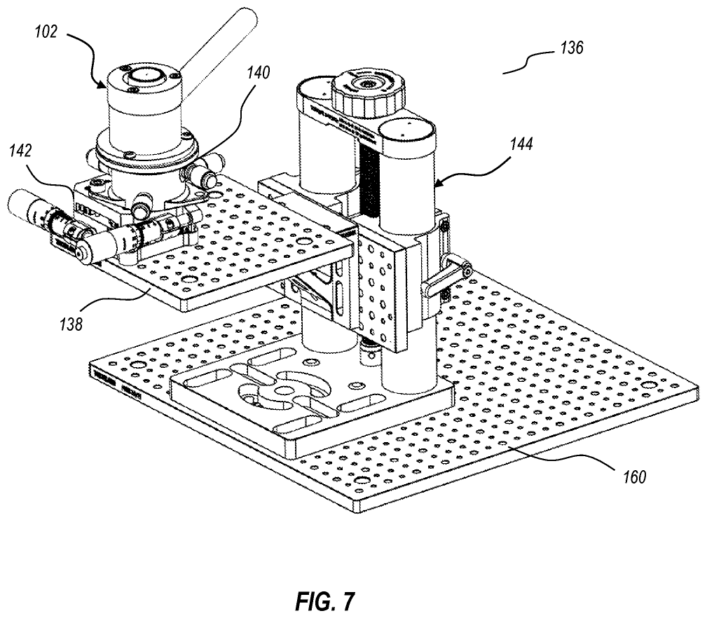

FIG. 7 illustrates a detailed view of the stage assembly 136. The stage assembly 136 supports the eye support assembly 102 and enables fine positional adjustment of the eye support assembly 102 relative to the scanner assembly 104 and tissue sampling assembly 106. The illustrated stage assembly 136 includes a stage platform 138 (e.g., MSB15/M Thorlabs, Newton, NJ) on which the eye support assembly 102 is positioned.

Connected between the eye support assembly 102 and the stage platform 138 is an orientation member 140 (e.g., TTR001, Thorlabs, Newton, NJ) and a horizontal translation member 142 (e.g., LX20/M, Thorlabs, Newton, NJ). The orientation member 140 enables tip, tilt, and rotation of the eye support assembly 102 relative to the stage platform 138. The horizontal translation member 142 enables horizontal movement of the eye support assembly 102 upon the stage platform 138 (i.e., movement in the “X” and “Y” directions).

The illustrated stage assembly also includes a vertical translation member 144 (e.g., VAP4/M, Thorlabs, Newton, NJ) configured to selectively move the stage platform 138 vertically (i.e., in the “Z” direction) relative to a base 160 (e.g., MSB30/M, Thorlabs, Newton, NJ). The vertical translation member 144 can thereby move the eye support assembly 102 vertically relative to the scanner assembly 104 and tissue sampling assembly 106.

An example method for obtaining an ocular tissue sample using the ocular tissue sampling device 100 includes: securing an ex vivo eye in the eye support assembly 102; imaging the eye using the scanner assembly 104 to identify a target tissue of the eye for biopsy; aligning an optical axis of the scanner assembly 104 with the target tissue of the eye (e.g., the fovea); moving the biopsy member 108 or 208 into alignment with the optical axis of the scanner assembly 104; and moving the scanner assembly 104 and biopsy member 108 or 208 vertically relative to the eye support assembly 102 to bring the biopsy member 108 or 208 into contact with the target tissue of the eye.

Imaging data can be sent to an external computer device (not shown) via wired and/or wireless connection between the scanner 105 and the external computer device. The image data can be utilized to identify and locate target tissue for extraction (e.g., the fovea). The orientation member 140 and horizontal translation member 142 can then be used to move the target tissue into the desired position (e.g., into alignment with the optical axis). The biopsy member 108 or 208 can be moved to the second configuration, ready for procurement of the target tissue.

To obtain the target tissue, the table 116 can be used to lower the biopsy member 108 or 208 toward the eye. The vertical translation member 144 can then be used to raise the target tissue the last few mm into the biopsy punch 124. Accordingly, the table 116 can be utilized for “gross” vertical adjustments while the vertical translation member 144 can be utilized for “fine” vertical adjustments. The process can then be reversed to move the biopsy member 108 or 208 out of the way, and the sample can be removed from the specimen.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about.” When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

The embodiments disclosed herein should be understood as comprising/including disclosed components, and may therefore include additional components not specifically described. Optionally, the embodiments disclosed herein are essentially free or completely free of components that are not specifically described. That is, non-disclosed components may optionally be completely omitted or essentially omitted from the disclosed embodiments. For example, .

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. An ocular tissue sampling device, comprising:
an eye support assembly configured to secure an ex vivo eye;
a scanner assembly configured to image the eye; and
a tissue sampling assembly connected to the scanner assembly and configured to obtain a tissue sample from the eye, the tissue sampling assembly comprising a biopsy member,
wherein the biopsy member is selectively adjustable between a first configuration for imaging of the eye and a second configuration for procurement of a tissue sample from the eye.

2. The ocular tissue sampling device of claim 1, wherein the scanner assembly comprises an optical axis, wherein in the first configuration the biopsy member is not aligned with the optical axis and in the second configuration the biopsy member is aligned with the optical axis.

3. The ocular tissue sampling device of claim 1, wherein the scanner assembly comprises an optical coherence tomography (OCT) scanner.

4. The ocular tissue sampling device of claim 1, wherein the scanner assembly comprises a distance sensor configured to determine distance between the scanner assembly and the eye support assembly.

5. The ocular tissue sampling device of claim 1, wherein the tissue sampling assembly includes a connector attached to the scanner assembly, wherein the connector enables the biopsy member to move between the first and second configurations.

6. The ocular tissue sampling device of claim 5, wherein the biopsy member is attached to the connector via a hinged connection, and wherein movement between the first and second configurations comprises moving the biopsy member about the hinged connection.

7. The ocular tissue sampling device of claim 5, wherein the biopsy member is selectively attachable to the connector via a slide connection, and wherein movement between the first and second configurations comprises attaching or detaching the biopsy member via the slide connection.

8. The ocular tissue sampling device of claim 7, wherein the slide connection of the connector and biopsy member comprises a mount track and corresponding grooves.

9. The ocular tissue sampling device of claim 1, wherein the biopsy member includes a biopsy mount and a biopsy punch detachably connected thereto.

10. The ocular tissue sampling device of claim 1, wherein the eye support assembly comprises a vacuum chamber and an eye holder connected to the vacuum chamber, wherein the eye holder is configured to receive a posterior segment of the eye and wherein the vacuum chamber is configured to provide suction to the eye to secure the eye within the eye holder.

11. The ocular tissue sampling device of claim 10, wherein the eye holder comprises a contoured and perforated upper surface.

12. The ocular tissue sampling device of claim 1, further comprising a stage assembly comprising a stage platform on which the eye support assembly is attached.

13. The ocular tissue sampling device of claim 12, wherein the stage assembly further comprises: an orientation member enabling tip, tilt, and rotation of the eye support assembly; and/or a horizontal translation member configured to selectively move the eye support assembly horizontally upon the stage platform.

14. The ocular tissue sampling device of claim 12, wherein the stage assembly further comprises a vertical translation member configured to selectively move the stage platform vertically and thereby move the eye support assembly vertically relative to the scanner assembly and tissue sampling assembly.

15. The ocular tissue sampling device of claim 1, further comprising a frame that includes a vertical support and a scanner mount attached to the vertical support, wherein the scanner assembly attaches to the scanner mount in a manner that enables rotation of the scanner assembly relative to the vertical support.

16. The ocular tissue sampling device of claim 15, wherein the frame further comprises a table from which the vertical support extends, wherein vertical table movement causes corresponding vertical movement of the scanner assembly and tissue sampling assembly.

17. An ocular tissue sampling device, comprising:
an eye support assembly configured to secure an ex vivo eye, the eye support assembly comprising a vacuum chamber and an eye holder connected to the vacuum chamber, wherein the eye holder comprises a contoured and perforated upper surface configured to receive a posterior segment of the eye, and wherein the vacuum chamber is configured to provide suction to the eye to secure the eye within the eye holder;
a scanner assembly configured to enable imaging of the eye, the scanner assembly comprising an optical axis and an optical coherence tomography (OCT) scanner; and
a tissue sampling assembly configured to obtain a tissue sample from the eye, the tissue sampling assembly including a connector attached to the scanner assembly, and a biopsy member,
wherein the connector enables selective adjustment of the biopsy member between
(i) a first configuration in which the biopsy member is not aligned with the optical axis to thereby enable imaging of the eye, and
(ii) a second configuration in which the biopsy member is aligned with the optical axis to thereby enable procurement of a tissue sample from the eye.

18. The ocular tissue sampling device of claim 17, further comprising a stage on which the eye support assembly is attached, wherein the stage is connected to a vertical translation member configured to selectively move the stage vertically and thereby move the eye support assembly vertically relative to the scanner assembly and tissue sampling assembly.

19. A method for obtaining an ocular tissue sample using an ocular tissue sampling device, the method comprising:
securing an ex vivo eye in an eye support assembly;
imaging the eye using a scanner assembly to identify a target tissue of the eye for biopsy;
aligning an optical axis of the scanner assembly with the target tissue of the eye;
moving a biopsy member into alignment with the optical axis of the scanner assembly; and
moving the scanner assembly and biopsy member relative to the eye support assembly to bring the biopsy member into contact with the target tissue of the eye.

20. The method of claim 19, wherein the target tissue of the eye comprises the fovea.
